(19) United States
(12) Patent Application Publication
(10) Pub. No.: US 2013/0058693 A1
(43) Pub. Date: Mar. 7, 2013

(54) Sheet Conveying Device, Fixing Device, and Wet-Type Image Forming Apparatus

(71) Applicants: Junya HIRAYAMA, Takarazuka-shi (JP); Shigeo Uetake, Takatsuki-shi (JP); Yuji Kamoda, Ibaraki-shi (JP); Toshiya Natsuhara, Takarazuka-shi (JP)

(72) Inventors: Junya HIRAYAMA, Takarazuka-shi (JP); Shigeo Uetake, Takatsuki-shi (JP); Yuji Kamoda, Ibaraki-shi (JP); Toshiya Natsuhara, Takarazuka-shi (JP)

(73) Assignee: Konica Minolta Business Technologies, Inc., Tokyo (JP)

(21) Appl. No.: 13/586,523

(22) Filed: Aug. 15, 2012

(30) Foreign Application Priority Data
Sep. 2, 2011 (JP) 2011-191434

(51) Int. Cl. G03G 15/00; B65H 5/00

(52) U.S. Cl. 399/381; 271/264

(57) ABSTRACT

A sheet conveying device configured to convey a sheet of paper from upstream to downstream of a conveying route includes a plurality of wire ropes configured to support and convey the sheet of paper in the conveying route, in which the plurality of wire ropes are arranged apart from each other, and at least two of the wire ropes are arranged so that a distance between them becomes larger as they come closer to downstream of the conveying route. The sheet conveying device can reduce an area of contact with the sheet of paper and reduce the occurrence of abnormal conveyance when conveying the sheet of paper.

This application is based on Japanese Patent Application No. 2011-191434 filed with the Japan Patent Office on Sep. 2, 2011, the entire content of which is hereby incorporated by reference.

### BACKGROUND OF THE INVENTION

1. Field of the Invention

The present invention relates to a sheet conveying device, a fixing device, and a wet-type image forming apparatus, and more particularly to a sheet conveying device for conveying a sheet of paper, a fixing device including the sheet conveying device, and a wet-type image forming apparatus including the fixing device.

2. Description of the Related Art

A sheet conveying device for conveying a sheet of paper is known, as disclosed in Japanese Laid-Open Patent Publication No. 2000-355453. The sheet conveying device for conveying a sheet of paper is used in a fixing device of an image forming apparatus for wet-type electrophotography (hereinafter referred to as wet-type image forming apparatus), for example. In recent years, the wet-type image forming apparatus has been widely used for an office printer, an on-demand printer or the like.

The wet-type image forming apparatus uses a liquid developer. The liquid developer generally includes carrier liquid such as a paraffinic solvent, and toner particles dispersed in the carrier liquid. In a development step or a transfer step of the wet-type image forming apparatus, electrophoresis due to an electric field causes the toner particles in the liquid developer to move onto a sheet of paper together with the carrier liquid.

In the wet-type image forming apparatus, the fixing device fixes the toner particles, which have been conveyed onto the sheet of paper, on the sheet of paper. A desired image is formed on the sheet of paper by the fixation of toner particles. A common fixing device uses a rubber belt as a sheet conveying device for conveying a sheet of paper.

### SUMMARY OF THE INVENTION

If a rubber belt is used as a sheet conveying device for conveying a sheet of paper, a large area of contact is provided between the rubber belt and the sheet of paper. If such sheet conveying device is used in a fixing device of a wet-type image forming apparatus, for example, a sheet of paper is not dried well in a toner fixation step, causing carrier liquid to remain in the sheet of paper. As a result, a so-called see-through phenomenon tends to occur in which characters are seen through the back side of the sheet of paper.

In order to facilitate drying to suppress the occurrence of the see-through phenomenon or the like, the rubber belt may be provided with a plurality of holes. While the drying of the sheet of paper is facilitated in portions provided with the holes, the sheet of paper is still not dried well in portions where the rubber belt makes contact with the sheet of paper. If a rubber belt is used as a sheet conveying device for conveying a sheet of paper, the large area of contact is provided between the rubber belt and the sheet of paper, resulting in disadvantages as described above.

The present invention was made in view of the circumstances as described above, and an object of the present invention is to provide a sheet conveying device capable of reducing an area of contact with a sheet of paper when conveying the sheet of paper, a fixing device including the sheet conveying device, and a wet-type image forming apparatus including the fixing device.

A sheet conveying device configured to convey a sheet of paper from upstream to downstream of a conveying route includes a plurality of wire ropes configured to support and convey the sheet of paper in the conveying route, in which the plurality of wire ropes are arranged apart from each other, and at least two of the wire ropes are arranged so that a distance between them becomes larger as they come closer to downstream of the conveying route. In the present invention, the term “wire rope” shall include everything generally called wire rope regardless of thickness, and also include a solid wire.

According to the present invention, a sheet conveying device capable of reducing an area of contact with a sheet of paper and reducing the occurrence of abnormal conveyance when conveying the sheet of paper, a fixing device including the sheet conveying device, and a wet-type image forming apparatus including the fixing device can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a wet-type image forming apparatus in a first embodiment.

FIG. 2 schematically shows a fixing device in the first embodiment.

FIG. 3 schematically shows a sheet conveying device in the first embodiment.

FIG. 4 is a perspective view showing a roller used in the sheet conveying device in the first embodiment.

FIG. 5 is a cross-sectional view taken along line V-V in a direction of arrows in FIG. 3.

FIG. 6 is a cross-sectional view taken along line VI-VI in a direction of arrows in FIG. 3.

FIG. 7 is a cross-sectional view taken along line VII-VII in a direction of arrows in FIG. 3.

FIG. 8 schematically shows a sheet conveying device in a modification of the first embodiment.

FIG. 9 is a plan view showing a sheet conveying device in a comparative example of the first embodiment.

FIG. 10 is a plan view showing a sheet conveying device in a second embodiment.

FIG. 11 is a plan view showing a sheet conveying device in a third embodiment.

FIG. 12 is a cross-sectional view taken along line XII-XII in a direction of arrows in FIG. 11.

FIG. 13 schematically shows a fixing device in a fourth embodiment.

FIG. 14 illustrates results of Example 1 and Comparative Example 1.

FIG. 15 illustrates results of Example 2, Comparative Example 2, and Example 3.

### DESCRIPTION OF THE PREFERRED EMBODIMENTS

Embodiments and examples based on the present invention will be described with reference to the drawings. The scope of the present invention is not necessarily limited to any reference to a number, an amount and the like made in the descriptions of the embodiments and examples, unless otherwise specified. The same or corresponding parts are designated by the same reference signs in the descriptions of the embodiments and examples, and redundant description may not be repeated.

### First Embodiment

(Wet-Type Image Forming Apparatus 100)

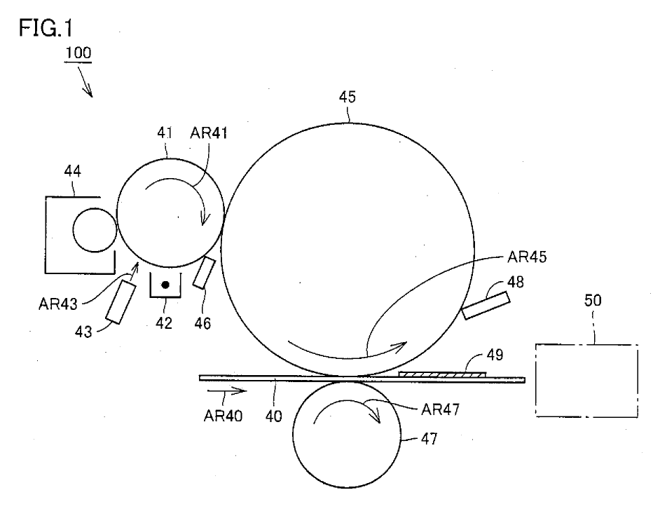

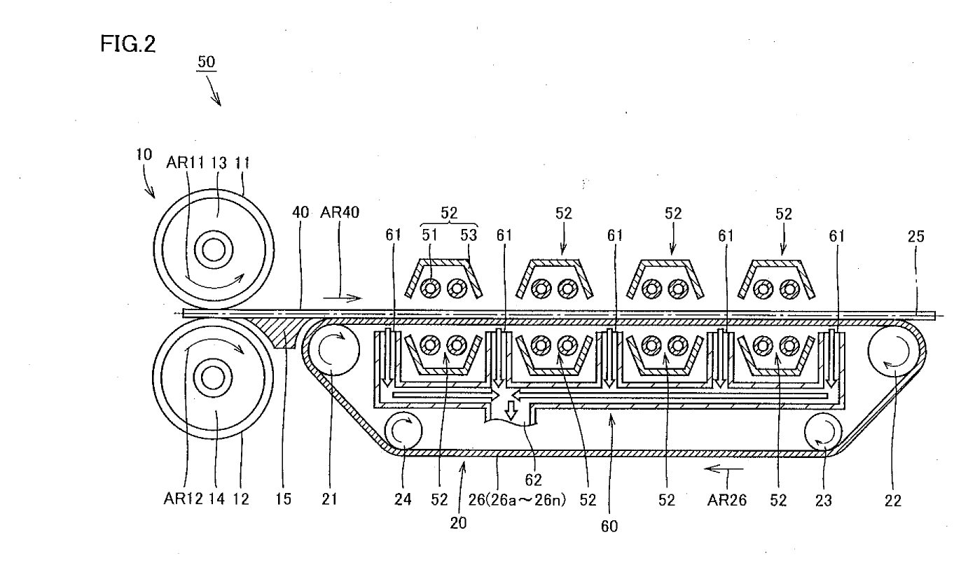

FIG. 1 schematically shows a wet-type image forming apparatus 100 in this embodiment. As shown in FIG. 1, wet-type image forming apparatus 100 includes a photoconductor drum 41, a charger 42, an exposure device 43, a liquid development device 44, an intermediate transfer roller 45, a cleaning device 46, a secondary transfer roller 47, a cleaning device 48, and a fixing device 50 (see also FIG. 2).

Photoconductor drum 41 is formed in a cylindrical shape, and has a photoconductor layer (not shown) provided on its surface. Photoconductor drum 41 rotates in a direction of an arrow AR41. Charger 42, exposure device 43, liquid development device 44, intermediate transfer roller 45, and cleaning device 46 are successively arranged around photoconductor drum 41 in the direction of rotation of photoconductor drum 41.

Charger 42 charges the surface of photoconductor drum 41 to a predetermined potential. Exposure device 43 irradiates the surface of photoconductor drum 41 with light based on predetermined image information (see an arrow AR43). The surface of photoconductor drum 41 is exposed to the light from exposure device 43, leading to a reduction in charging level of the surface of photoconductor drum 41. As a result of this reduction in charging level, an electrostatic latent image is formed on the surface of photoconductor drum 41.

Liquid development device 44 includes a liquid developer (not shown). The liquid developer contains carrier liquid and toner particles. A development bias voltage of the same polarity as the toner particles is applied to a development roller of liquid development device 44. A predetermined potential difference is provided between the development roller having the toner particles on its surface and the electrostatic latent image on photoconductor drum 41.

By the action of an electric field formed between the development roller of liquid development device 44 and photoconductor drum 41, the liquid developer of liquid development device 44 is conveyed onto the surface (development region) of photoconductor drum 41. The carrier liquid and toner particles in the liquid developer are electrostatically adsorbed on the surface of photoconductor drum 41. When the electrostatic latent image is developed, a toner image (not shown) corresponding to the shape of the electrostatic latent image is formed on the surface of photoconductor drum 41.

(Primary Transfer)

Intermediate transfer roller 45 is arranged to face photoconductor drum 41. Intermediate transfer roller 45 rotates in a direction of an arrow AR45 while making contact with photoconductor drum 41. At a contact portion (nip portion) between photoconductor drum 41 and intermediate transfer roller 45, the toner image on the surface of photoconductor drum 41 is transferred from photoconductor drum 41 to a surface of intermediate transfer roller 45 (primary transfer).

During the primary transfer, a transfer bias voltage of the opposite polarity to the toner particles contained in the toner image formed on photoconductor drum 41 is applied to intermediate transfer roller 45. An electric field is formed at the nip portion between photoconductor drum 41 and intermediate transfer roller 45. By the action of this electric field, the carrier liquid and toner particles forming the toner image are conveyed onto the surface of intermediate transfer roller 45. The carrier liquid and toner particles forming the toner image are electrostatically adsorbed on the surface of intermediate transfer roller 45.

Part of the carrier liquid and toner particles left on photoconductor drum 41 without being transferred is removed from the surface of photoconductor drum 41 by cleaning device 46. The surface of photoconductor drum 41 is cleaned and becomes available for the next image formation.

(Secondary Transfer)

Secondary transfer roller 47 is arranged to face intermediate transfer roller 45. A sheet of paper 40 (print medium) is conveyed to pass between secondary transfer roller 47 and intermediate transfer roller 45 (see an arrow AR40). Secondary transfer roller 47 rotates in a direction of an arrow AR47, with sheet of paper 40 being sandwiched between secondary transfer roller 47 and intermediate transfer roller 45. At a nip portion between secondary transfer roller 47 and intermediate transfer roller 45, the toner image on the surface of intermediate transfer roller 45 is transferred from intermediate transfer roller 45 to a surface of sheet of paper 40 (secondary transfer).

During the secondary transfer, a transfer bias voltage of the opposite polarity to the toner particles contained in the toner image formed on intermediate transfer roller 45 is applied to secondary transfer roller 47. An electric field is formed at the nip portion between intermediate transfer roller 45 and secondary transfer roller 47. By the action of this electric field, the carrier liquid and toner particles forming the toner image are conveyed onto the surface of sheet of paper 40 passing through the nip portion. The carrier liquid and toner particles forming the toner image are electrostatically adsorbed on the surface of sheet of paper 40.

A toner image 49 is formed on sheet of paper 40. Sheet of paper 40 with toner image 49 formed thereon is conveyed into fixing device 50. Toner image 49 is fixed on the surface of sheet of paper 40 by fixing device 50. Toner image 49 is described with reference to FIG. 2).

Part of the carrier liquid and toner particles left on intermediate transfer roller 45 without being transferred is removed from the surface of intermediate transfer roller 45 by cleaning device 48. The surface of intermediate transfer roller 45 is cleaned and becomes available for the next image formation.

(Liquid Developer)

The liquid developer used in this embodiment contains a high concentration of colored toner particles dispersed in the carrier liquid which is a solvent, as described above. A dispersing agent, a charge-controlling agent or the like may be added to the liquid developer. A nonvolatile solvent which is insulative and does not volatilize at room temperature is used as the carrier liquid. Examples of the nonvolatile solvent to be used include silicone oil, mineral oil or paraffin oil.

The toner particles include resin, and pigment or dye for coloring. The resin has the function of dispersing the pigment or dye uniformly in the resin, and the function of a binder during fixation of the toner particles on the sheet of paper. Examples of the resin to be used include thermoplastic resin such as polystyrene resin, styrene-acrylic resin, acrylic resin, polyester resin, epoxy resin, polyimide resin, polyimide resin, or polyurethane resin. A plurality of resins selected from these resins can be mixed and used for the toner particles.

Commercially available pigments or dyes can be used to color the toner. Examples of the pigment to be used include carbon black, iron red, titanium oxide, silica, phthalocyanine blue, phthalocyanine green, sky blue, benzidine yellow, or lake red D. Examples of the dye to be used include Solvent Red 27 or Acid Blue 9.

The liquid developer can be prepared with a generally used method. For example, the resin and pigment blended at a predetermined ratio are melted and kneaded using a pressure kneader, a roll mill or the like. The resultant dispersive product obtained by uniformly dispersing the resin and pigment is finely ground by a jet mill, for example. The resultant fine powders are classified by a wind classifier, for example. As a result, colored toner having a predetermined particle size is obtained.

The resultant colored toner and the insulative liquid serving as the carrier liquid are mixed with each other at a predetermined ratio. This mixture is uniformly dispersed by dispersing means such as a ball mill. The liquid developer is thus obtained.

Preferably, the toner particles in the liquid developer have a volume-average particle size of not less than 0.1 μm and not more than 5 μm. If the toner particles in the liquid developer have a volume-average particle size of less than 0.1 μm, it is difficult to develop those toner particles. If the toner particles in the liquid developer have a volume-average particle size of more than 5 μm, a toner image formed from those toner particles will have a lower quality.

Preferably, a ratio of the mass of the toner particles to the mass of the entire liquid developer is not less than 10% and not more than 50%. If the ratio of the mass of the toner particles to the mass of the liquid developer is less than 10%, sedimentation of the toner particles tends to occur, resulting in a decrease in stability over time during long-term storage. If the ratio of the mass of the toner particles to the mass of the liquid developer is less than 10%, a large amount of developer needs to be supplied in order to obtain a desired image density. The amount of carrier liquid to be supplied to the sheet of paper increases, resulting in the need to dry the large amount of carrier liquid when fixing a toner image. This is not preferable because a large amount of vapor is generated from the carrier liquid when the carrier liquid is dried.

If the ratio of the mass of the toner particles to the mass of the liquid developer is more than 50%, the viscosity of the liquid developer becomes too high, which is disadvantageous in terms of manufacturing and handling. Preferably, the liquid developer has a viscosity of not less than 0.1 mPa·s and not more than 10000 mPa·s at 25° C. If the liquid developer has a viscosity of more than 10000 mPa·s, it is difficult to handle the liquid developer during agitation and delivery of the developer. This places a burden on the device in order to obtain a uniform liquid developer. If the liquid developer has a viscosity of less than 0.1 mPa·s, on the other hand, it is difficult to control the amount of toner on the development roller, and thus to realize an appropriate image density.

As described above, the toner particles used in wet-type image forming apparatus 100 have a particle size smaller than that of toner particles used in a so-called dry-type image forming apparatus. According to wet-type image forming apparatus 100, the toner image is resistant to distortion. According to wet-type image forming apparatus 100, the toner image having high quality and high resolution is formed on the sheet of paper.

(Fixing Device 50)

FIG. 2 schematically shows fixing device 50 in this embodiment. As shown in FIG. 2, fixing device 50 includes a fixing unit 10, a sheet conveying device 20, heating units 52, and a wind pressure generator 60. Heating units 52 and wind pressure generator 60 can be considered as part of sheet conveying device 20.

Fixing unit 10 includes a fixing roller 11 and a fixing roller 12 arranged to face each other with a distance therebetween. Fixing roller 11 is a hollow roller. Fixing roller 11 has a rubber layer having a thickness of 2 mm to 5 mm provided on its surface, and a heater 13 for heating provided therein.

Fixing roller 12 is also a hollow roller. Fixing roller 12 also has a rubber layer having a thickness of 2 mm to 5 mm provided on its surface, and a heater 14 for heating provided therein.

Fixing roller 11 rotates in a direction of an arrow AR11. Fixing roller 12 rotates in a direction of an arrow AR12. Sheet of paper 40 is conveyed to pass between fixing rollers 11 and 12. Sheet of paper 40 is heated and pressurized by fixing rollers 11 and 12.

The toner particles on the surface of sheet of paper 40 are melted by passing between fixing rollers 11 and 12. The melted toner particles are fixed as a toner image on the surface of sheet of paper 40. Sheet of paper 40 is then ejected from fixing unit 10 (see arrow AR40).

(Sheet conveying device 20)

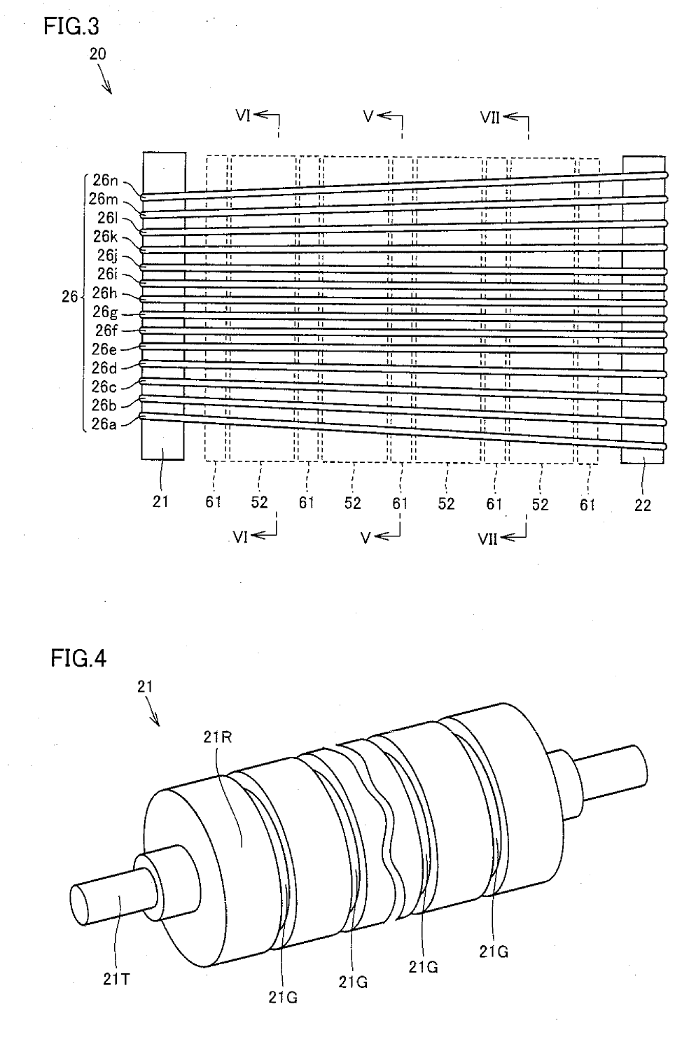

FIG. 3 is a plan view showing sheet conveying device 20 in this embodiment. As shown in FIGS. 2 and 3, sheet conveying device 20 is provided downstream of fixing unit 10. A guide plate 15 having a horizontally-held surface (see FIG. 2) may be provided between fixing unit 10 and sheet conveying device 20. Sheet conveying device 20 includes rollers 21 to 24, and a plurality of wire ropes 26 (wire ropes 26a to 26n).

As shown in FIG. 4, roller 21 includes a rotating shaft portion 21T, a cylindrical portion 21R, and a plurality of circumferential grooves 21G. Cylindrical portion 21R rotates when rotating shaft portion 21T is driven by a driver (not shown). The plurality of circumferential grooves 21G are annularly provided as individual recessed grooves in a surface of cylindrical portion 21R. Each of the plurality of wire ropes 26 (see FIGS. 2 and 3) is wound around each of the plurality of circumferential grooves 21G.

Rollers 22 to 24 (see FIG. 2) are configured in a manner similar to that of roller 21. One or a plurality of rollers 21 to 24 may function as driving rollers, and the rest of rollers 21 to 24 may function as driven rollers. The plurality of wire ropes 26 are formed as endless ropes, and would around rollers 21 to 24 annularly as a whole.

Each of wire ropes 26 is formed of endless strands made of steel. Each of wire ropes 26 is formed as a rope by bundling together and stranding a plurality of strands each including a plurality of stranded constituent wires. The constituent wires can be stranded in any direction. In this embodiment, lang lay wire ropes 26 are used in which the strands and ropes are stranded in the same direction. Each of the constituent wires has a diameter of 0.11 mm, for example. A strand consists of 19 constituent wires, for example. Each of wire rope 26 includes seven strands, for example. Each of wire ropes 26 has a rope diameter of 1.0 mm, for example. Each of wire ropes 26 may be a solid wire.

When the driving rollers formed of one or a plurality of rollers 21 to 24 rotate, the plurality of wire ropes 26 rotate in a direction of an arrow AR26 (see FIG. 2). A portion of the plurality of wire ropes 26 located between rollers 21 and 22 forms a conveying route 25 (see FIG. 2) for conveying sheet of paper 40. The distance between rollers 21 and 22 is set to 600 mm, for example.

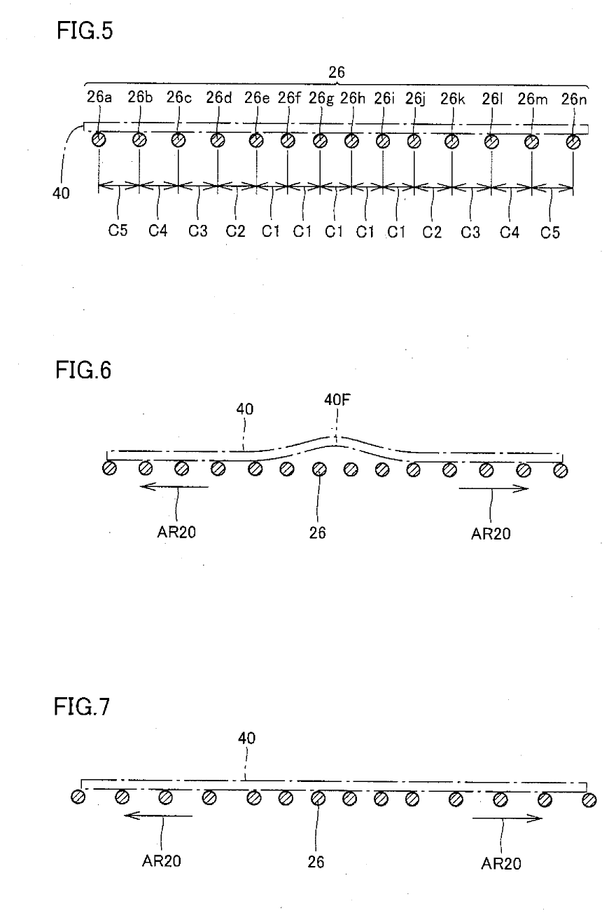

When the plurality of wire ropes 26 are driven to rotate, the plurality of wire ropes 26 support and convey sheet of paper 40 on conveying route 25 from upstream (left side in the plane of the drawing of FIGS. 2 and 3) to downstream (right side in the plane of the drawing of FIGS. 2 and 3) of conveying route 25. As will be described later in detail, the plurality of wire ropes 26 wound around rollers 21 to 24 (see FIG. 2) are arranged apart from each other by predetermined distances C1 to C5 (see FIG. 5).

(Heating Units 52)

Referring to FIGS. 2 and 3, heating units 52 are arranged apart from conveying route 25 (see FIG. 2) to sandwich conveying route 25. Each of the plurality of heaters 52 includes a far-infrared heater 51 serving as a heat source, and a radiation plate 53. Heating units 52 are adjacent to each other with a predetermined distance therebetween, where a suction inlet 61 of wind pressure generator 60 to be described later is arranged. Sheet of paper 40 conveyed on conveying route 25 can be heated from both sides by the plurality of heating units 52.

As described above, in wet-type image forming apparatus 100 (see FIG. 1), when the toner image is transferred to one surface of sheet of paper 40, the carrier liquid permeates inside of sheet of paper 40 from the one surface of sheet of paper 40. The carrier liquid hardly volatilizes at room temperature. After the toner particles were fixed on the surface of sheet of paper 40 by fixing unit 10, sheet of paper 40 is heated from both sides by heating units 52. The carrier liquid that has permeated inside of sheet of paper 40 is volatilized (dried) by this heating, thereby suppressing the occurrence of the so-called see-through phenomenon.

As described above, each of wire ropes 26 for conveying sheet of paper 40 has a diameter of 1.0 mm, for example. The area of contact between the plurality of wire ropes 26 and sheet of paper 40 is extremely small as compared to an example where sheet of paper 40 is conveyed with a rubber belt. Sheet of paper 40 can be effectively heated by heating units 52 not only from the surface side, but also from the back side supported by the plurality of wire ropes 26. According to fixing device 50 including sheet conveying device 20, therefore, the occurrence of the so-called see-through phenomenon can be effectively suppressed.

(Wind Pressure Generator 60)

In this embodiment, wind pressure generator 60 is used when conveying sheet of paper 40, in order to effectively obtain a driving force (frictional force) of the plurality of wire ropes 26 for sheet of paper 40. Wind pressure generator 60 includes a discharge outlet 62 and a plurality of suction inlets 61. One suction inlet 61 is arranged between two adjacent ones of heating units 52. A propeller is provided on extension of discharge outlet 62, for example. When the air is suctioned from suction inlets 61 to discharge outlet 62 by rotation of the propeller, a negative pressure (normal force) is generated between suction inlets 61 and sheet of paper 40. Due to the generated negative pressure, sheet of paper 40 can be conveyed while being pressed against (adsorbed on) the surfaces of the plurality of wire ropes 26.

(Wire Ropes 26a to 26n)

FIG. 5 is a cross-sectional view taken along line V-V in a direction of arrows in FIG. 3. The plurality of wire ropes 26 wound around rollers 21 to 24 (see FIG. 2) are arranged apart from each other by predetermined distances C1 to C5.

Distances C2 to C5 between any two adjacent ones of the plurality of wire ropes 26a to 26n are set to gradually become larger from upstream toward downstream of conveying route 25 (see FIG. 2). In this embodiment, wire ropes 26e to 26j arranged in an inner side of the plurality of ropes in a width direction of the conveying route are arranged in parallel. Distance C1 between adjacent ones of wire ropes 26e to 26j has the same value between upstream and downstream of conveying route 25 (see FIG. 2). In this embodiment, distance C1 is set to 7 mm both upstream (above roller 21) and downstream (above roller 22).

On the other hand, distances C2 to C5 between adjacent ones of wire ropes 26a to 26e arranged in an outer side of the plurality of ropes are set to gradually become larger from upstream toward downstream of conveying route 25 (see FIG. 2). Distances C2 to C5 between adjacent ones of wire ropes 26j to 26n arranged in an outer side of the plurality of ropes are also set to gradually become larger from upstream toward downstream of conveying route 25 (see FIG. 2). In this embodiment, distances C2 to C5 are set to 7 mm upstream (above roller 21), and 10 mm downstream (above roller 22). The distances may be set to satisfy relation of distance C1<distance C2<distance C3<distance C4<distance C5. While distance C1 has the same value between upstream and downstream of conveying route 25 in this embodiment, distance C1 may be set to gradually become larger from upstream toward downstream of conveying route 25, as with distances C2 to C5.

FIG. 6 is a cross-sectional view taken along line VI-VI in a direction of arrows in FIG. 3. FIG. 6 shows a relatively upstream portion of conveying route 25 (see FIG. 2). As shown in FIG. 6, sheet of paper 40 may be conveyed by the plurality of wire ropes 26 while having a raised portion 40F. This raised portion is believed to occur when the sheet of paper is partially raised from a conveying surface while being conveyed due to vibration of the wire ropes, and the raised part is gathered to the center. If the sheet of paper is conveyed with the raised portion, wrinkles and the like may be formed in the sheet of paper during or after conveyance. In order to reduce the occurrence of such abnormal conveyance, a distance between any two adjacent ones of the plurality of wire ropes is set to gradually become larger from upstream toward downstream of the conveying route, as will be described below.

In a portion where the distance between adjacent ones of wire ropes 26 is set to gradually become larger from upstream toward downstream of conveying route 25 (see FIG. 2), wire ropes 26 provide sheet of paper 40 with a frictional force in directions of arrows AR20. The frictional force in the directions of arrows AR20 is in a direction (lateral direction) perpendicular to the conveying direction of sheet of paper 40.

Sheet of paper 40 is conveyed on conveying route 25 (see FIG. 2) from upstream to downstream while making sliding contact with wire ropes 26 having the distance set to gradually become larger from upstream toward downstream of conveying route 25 (see FIG. 2). Sheet of paper 40 is conveyed to gradually spread in the lateral direction.

FIG. 7 is a cross-sectional view taken along line VII-VII in a direction of arrows in FIG. 3. FIG. 7 shows a relatively downstream portion of conveying route 25 (see FIG. 2). As shown in FIG. 7, since the frictional force in the directions of arrows AR20 is provided to sheet of paper 40, raised portion 40F (see FIG. 6) disappears (or almost disappears) downstream of conveying route 25 (see FIG. 2). Sheet of paper 40 can be conveyed while making uniform contact with the plurality of wire ropes 26.

If an ejecting unit of sheet of paper 40 or another fixing unit is provided downstream of fixing device 50, for example, sheet of paper 40 can be introduced into the ejecting unit or the another fixing unit without wrinkles and the like.

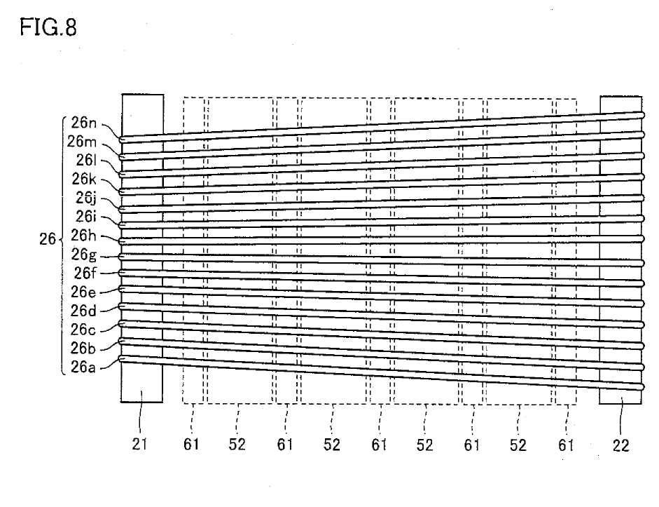

In this embodiment, the wire ropes arranged in the inner side of the plurality of wire ropes are arranged in parallel, and the distance between adjacent ones of the wire ropes arranged in the outer side is set to gradually become larger from upstream toward downstream of the conveying route. Alternatively, as shown in FIG. 8, the distance between adjacent ones of all of the plurality of wire ropes may be set to gradually become larger from upstream toward downstream.

(Function/Effect)

According to fixing device 50 including sheet conveying device 20, and wet-type image forming apparatus 100 including fixing device 50, sheet of paper 40 is heated from both sides by heating units 52. The area of contact between the plurality of wire ropes 26 and sheet of paper 40 is extremely small as compared to an example where sheet of paper 40 is conveyed with a rubber belt. The carrier liquid that has permeated inside of sheet of paper 40 is volatilized due to the heating by heating units 52, thereby effectively suppressing the occurrence of the so-called see-through phenomenon. Furthermore, by setting the distance between at least two adjacent ones of the plurality of wire ropes 26 to gradually become larger from upstream toward downstream of conveying route 25, the occurrence of abnormal conveyance such as raised paper can be effectively suppressed.

Since fixing rollers 11 and 12 of fixing unit 10 make contact with sheet of paper 40 only for a short period of time, it is difficult to volatilize the carrier liquid using only fixing rollers 11 and 12. The carrier liquid may be volatilized by raising the temperature of fixing rollers 11 and 12, or by increasing the diameter of fixing rollers 11 and 12. In such cases, however, the melted toner particles tend to attach to the surfaces of fixing rollers 11 and 12 (the so-called offset phenomenon tends to occur).

In this embodiment, sheet conveying device 20 and heating units 52 are arranged downstream of fixing unit 10. Sheet of paper 40 passes between heating units 52 arranged to face each other to sandwich conveying route 25, while having a temperature that has been raised to some degree by fixing unit 10. Heating units 52 volatilize the carrier liquid by utilizing thermal energy that has been provided to sheet of paper 40 in fixing unit 10. Since less energy is required for heating units 52 to volatilize the carrier liquid, fixing device 50 is energy efficient.

Each of heating units 52 may include a fan or the like for blowing heat generated by far-infrared heater 51 onto the surface of sheet of paper 40 as hot air. The carrier liquid that has permeated inside of sheet of paper 40 can be further volatilized by the hot air.

Moreover, wind pressure generator 60 may be configured, in addition to suctioning the air by suction inlets 61 to adsorb sheet of paper 40 on the plurality of wire ropes 26, to blow the air from the surface side of sheet of paper 40 to press sheet of paper 40 against the plurality of wire ropes 26.

(Comparative Example)

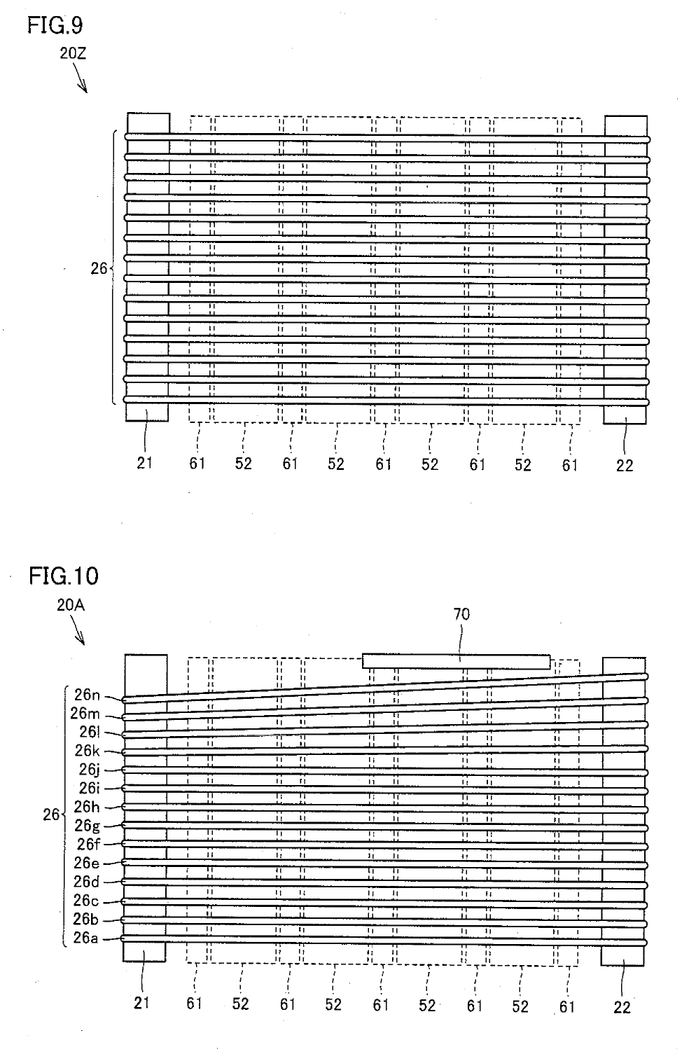

Referring to FIG. 9, a sheet conveying device 20Z in a comparative example includes the plurality of wire ropes 26 arranged in parallel. In this case, the force in the direction (lateral direction) perpendicular to the conveying direction of sheet of paper 40 is not generated on sheet of paper 40. While being conveyed by the plurality of wire ropes 26, sheet of paper 40 does not make sliding contact with the plurality of wire ropes 26 to spread. If raised portion 40F (see FIG. 6) occurs in sheet of paper 40, sheet of paper 40 is conveyed with raised portion 40F.

In contrast, according to sheet conveying device 20 (see FIG. 3 and the like) in this embodiment (first embodiment), sheet of paper 40 is conveyed to gradually spread in the lateral direction. Sheet of paper 40 can be ejected from the ejecting unit or the like without wrinkles and the like. Therefore, sheet conveying device 20 in this embodiment can be utilized particularly effectively for conveying so-called cut sheets.

### Second Embodiment

Referring to FIG. 10, a sheet conveying device 20A in this embodiment will be described. FIG. 10 is a plan view showing sheet conveying device 20A.

In sheet conveying device 20A, wire ropes 26a to 26j of the plurality of wire ropes 26 are arranged in parallel. A distance between adjacent ones of wire ropes 26a to 26j has the same value between upstream and downstream of conveying route 25 (see FIG. 2). The number of wire ropes 26a to 26j is about two-thirds of the total number of the plurality of wire ropes 26.

A distance between adjacent ones of wire ropes 26k to 26n arranged in one outer side of the plurality of ropes is set to gradually become larger from upstream toward downstream of conveying route 25 (see FIG. 2). The number of wire ropes 26k to 26n is about one-third of the total number of the plurality of wire ropes 26. The distance between adjacent ones of wire ropes 26k to 26n is set to 7 mm upstream (above roller 21), and 10 mm downstream (above roller 22). With this configuration, sheet of paper 40 conveyed on conveying route 25 (see FIG. 2) is conveyed diagonally in a direction toward wire rope 26n arranged in the one outer side.

On a side (outside of wire rope 26n) of conveying route 25 (see FIG. 2), a plate-like guide member 70 for regulating travel of sheet of paper 40 (see FIG. 2) conveyed in the diagonal direction is provided so that sheet of paper 40 will not travel in the diagonal direction beyond a predetermined distance.

According to sheet conveying device 20A, sheet of paper 40 is conveyed on conveying route 25 (see FIG. 2) from upstream to downstream while making sliding contact with wire ropes 26 having the distance set to gradually become larger from upstream toward downstream of conveying route 25 (see FIG. 2). Sheet of paper 40 is conveyed to gradually spread in the lateral direction. Sheet of paper 40 can be conveyed without wrinkles and the like.

Furthermore, sheet of paper 40 is guided to approach guide member 70 while being conveyed by the plurality of wire ropes 26. An end portion of sheet of paper 40 abuts guide member 70. When sheet of paper 40 abuts guide member 70, the orientation (tilt) of sheet of paper 40 is corrected to a predetermined angle. Sheet of paper 40 can be ejected from fixing device 50 at the predetermined angle.

### Third Embodiment

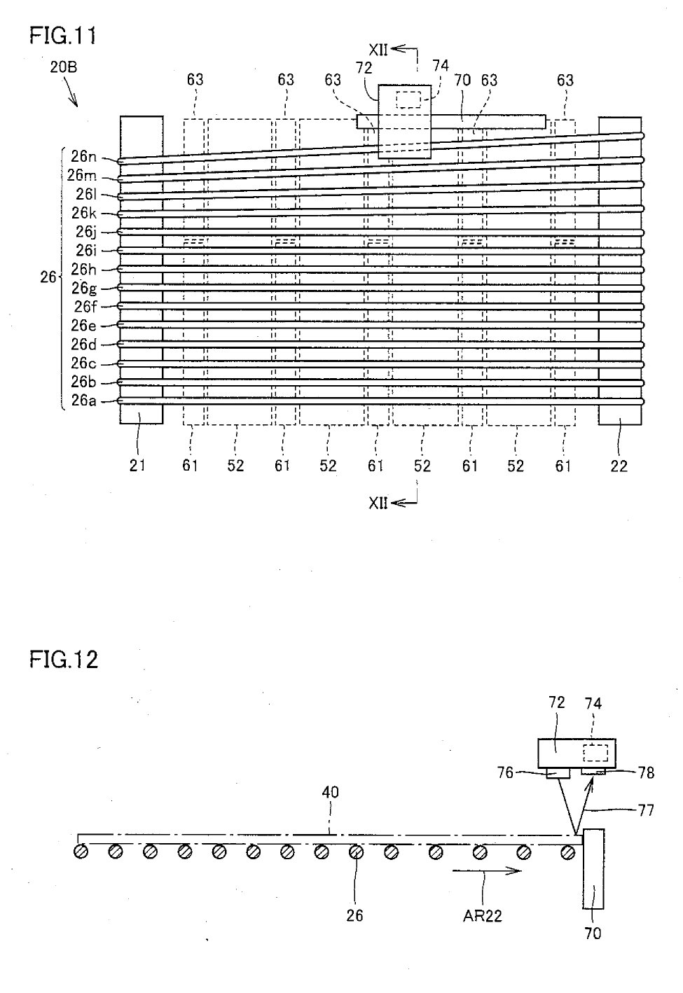

Referring to FIGS. 11 and 12, a sheet conveying device 20B in this embodiment will be described. FIG. 11 is a plan view showing sheet conveying device 20B. FIG. 12 is a cross-sectional view taken along line XII-XII in a direction of arrows in FIG. 11.

As shown in FIG. 11, in sheet conveying device 20B, suction inlets 63 controlled independently of suction inlets 61 are provided on the side of guide member 70. A reflective sensor 72 (detector) including a controller 74 therein is provided above guide member 70. Controller 74 is connected to wind pressure generator 60 (see FIG. 2). Controller 74 controls a driving amount of wind pressure generator 60, to adjust the amount of air suctioned by suction inlets 63, or to stop the suction of air by suction inlets 63.

In this embodiment as well, sheet of paper 40 conveyed on conveying route 25 (see FIG. 2) is conveyed diagonally in the direction toward wire rope 26n arranged in the one outer side.

Reflective sensor 72 detects, when a light receiving unit 78 receives sensor light 77 from a light projecting unit 76, that sheet of paper 40 moving in the diagonal direction (see an arrow AR22 in FIG. 12) has reached a predetermined position in the diagonal direction. Reflective sensor 72 in this embodiment detects that the end portion of sheet of paper 40 has abutted guide member 70.

When reflective sensor 72 detects that the end portion of sheet of paper 40 has abutted guide member 70, controller 74 adjusts the amount of air suctioned by suction inlets 63 so that sheet of paper 40 will not travel in the diagonal direction (see arrow AR22 in FIG. 12) beyond the predetermined distance. By reducing the amount of air suctioned by suction inlets 63 (or stopping the suction of air by suction inlets 63), sheet of paper 40 stops moving in the diagonal direction (see arrow AR22), and will be guided by guide member 70 to be conveyed straight from roller 21 to roller 22.

According to sheet conveying device 20B, when sheet of paper 40 abuts guide member 70, the orientation (tilt) of sheet of paper 40 is corrected to the predetermined angle. Controller 74 controls wind pressure generator 60 (see FIG. 2), to prevent sheet of paper 40 from excessively abutting guide member 70. Buckling, wrinkles and the like of sheet of paper 40 that occur when sheet of paper 40 excessively abuts guide member 70 can be prevented.

### Fourth Embodiment

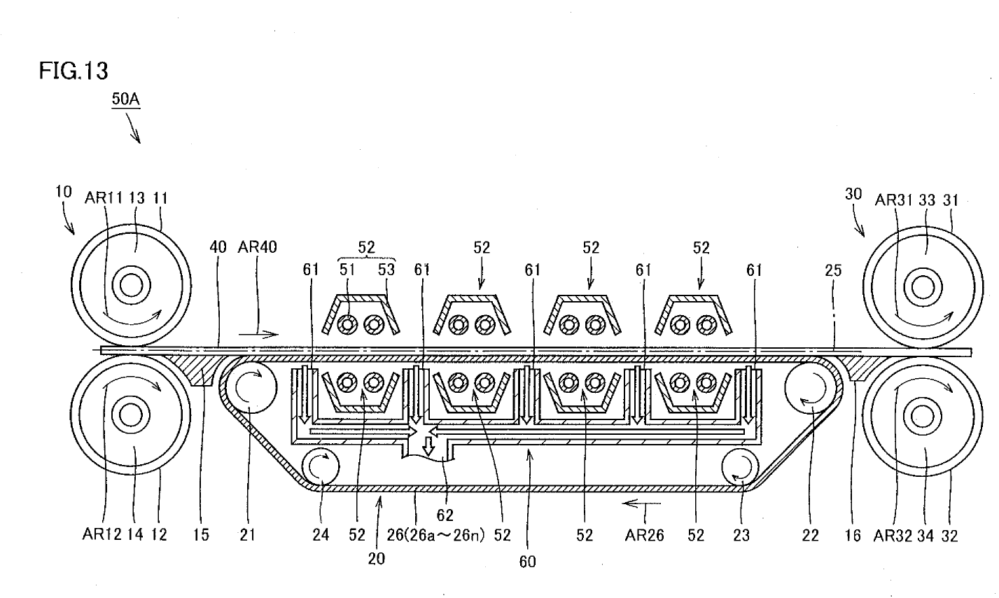

Referring to FIG. 13, a fixing device 50A in this embodiment will be described. Fixing device 50 in the first to third embodiments (see FIG. 2) includes fixing unit 10 provided upstream of sheet conveying device 20, as a fixing unit. Fixing device 50A in this embodiment further includes a fixing unit 30 provided downstream of sheet conveying device 20, as a fixing unit. A guide plate 16 having a horizontally-held surface may be provided between sheet conveying device 20 and fixing unit 30.

Fixing unit 30 includes a fixing roller 31 and a fixing roller 32 arranged to face each other with a distance therebetween. Fixing roller 31 is a hollow roller. Fixing roller 31 has a rubber layer having a thickness of 2 mm to 5 mm provided on its surface, and a heater 33 for heating provided therein.

Fixing roller 32 is also a hollow roller. Fixing roller 32 also has a rubber layer having a thickness of 2 mm to 5 mm provided on its surface, and a heater 34 for heating provided therein.

Fixing roller 31 rotates in a direction of an arrow AR31. Fixing roller 32 rotates in a direction of an arrow AR32. Sheet of paper 40 that has been conveyed by sheet conveying device 20 is further conveyed to pass between fixing rollers 31 and 32. Sheet of paper 40 is heated and pressurized by fixing rollers 31 and 32.

The toner particles on the surface of sheet of paper 40 are further fixed as a toner image on the surface of sheet of paper 40 by passing between fixing rollers 31 and 32. Sheet of paper 40 is then ejected from fixing unit 30.

If the toner image that has been fixed on sheet of paper 40 by fixing unit 10 has a sufficient fix level, it is unnecessary to provide fixing unit 30 as in the first to third embodiments. If the toner image has an insufficient fix level, a sufficient fix level as a toner image can be obtained by using fixing unit 30.

### [EXAMPLE 1/COMPARATIVE EXAMPLE 1]

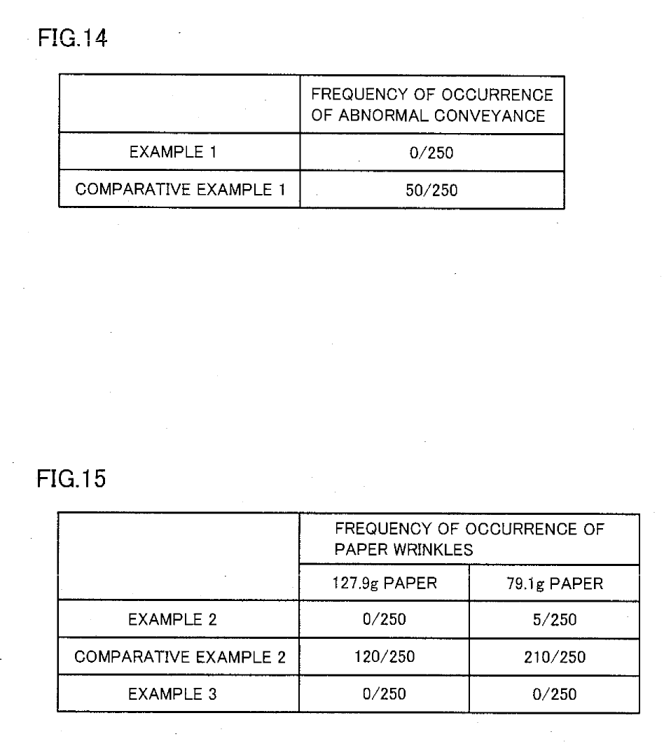

Referring to FIG. 14, Example 1 and its corresponding Comparative Example 1 will be described. In Example 1, sheet conveying device 20 (see FIGS. 2 to 7) and fixing device 50 (which includes fixing unit 10 as a fixing unit) (see FIG. 2) based on the first embodiment were used. In Comparative Example 1, sheet conveying device 20Z based on the comparative example (see FIG. 9) and fixing device 50 (which includes fixing unit 10 as a fixing unit) (see FIG. 2) were used.

Under these conditions, 250 sheets of paper 40 of A3 size were conveyed. As sheets of paper 40, OK Topcoat+ (Topcoat is a registered trademark) available from Oji Paper Co., Ltd. (weight per unit area: 127.9 g/m²) was used. A state of each sheet of paper 40 at a terminating end of each of sheet conveying device 20 and sheet conveying device 20Z was visually confirmed, and the number of sheets of paper 40 that were conveyed with a raised portion from wire ropes 26 was counted as abnormal conveyance.

As a result, as shown in FIG. 14, the frequency of occurrence of abnormal conveyance was 0 sheet out of 250 sheets in Example 1. On the other hand, the frequency of occurrence of abnormal conveyance was about 50 sheets out of 250 sheets in Comparative Example 1. It is thus shown that sheet of paper 40 can be ejected without wrinkles and the like in the first embodiment described above (see FIGS. 2 to 7).

### [EXAMPLE 2/COMPARATIVE EXAMPLE 2]

Referring to FIG. 15, Example 2 and its corresponding Comparative Example 2 will be described. In Example 2, sheet conveying device 20A based on the second embodiment (see FIG. 10) and fixing device 50A based on the fourth embodiment (which includes fixing units 10 and 30 as fixing units) (see FIG. 13) were used. In Comparative Example 2, sheet conveying device 20Z based on the comparative example (see FIG. 9) and fixing device 50 (which includes fixing units 10 and 30 as fixing units) (see FIG. 13) were used.

Under these conditions, 250 sheets of paper 40 of A3 size were conveyed. As sheets of paper 40, OK Topcoat+ (Topcoat is a registered trademark) available from Oji Paper Co., Ltd. was used. As sheets of paper 40, sheets having a weight per unit area of 127.9 g/m² and sheets having a weight per unit area of 79.1 g/m² were used. A state of each sheet of paper 40 ejected from fixing unit 30 was confirmed.

As a result, as shown in FIG. 15, in Example 2, the frequency of occurrence of wrinkles in sheets of paper 40 having a weight per unit area of 127.9 g/m² was 0 sheet out of 250 sheets, and the frequency of occurrence of wrinkles in sheets of paper 40 having a weight per unit area of 79.1 g/m² was about 5 sheets out of 250 sheets. On the other hand, in Comparative Example 2, the frequency of occurrence of wrinkles in sheets of paper 40 having a weight per unit area of 127.9 g/m² was about 120 sheets out of 250 sheets, and the frequency of occurrence of wrinkles in sheets of paper 40 having a weight per unit area of 79.1 g/m² was about 210 sheets out of 250 sheets. It is believed that the frequency of occurrence of wrinkles was high in Comparative Example 2 because sheets of paper 40 were not conveyed with a designed tilt due to the absence of guide member 70.

According to sheet conveying device 20A based on the second embodiment (see FIG. 10) and fixing device 50A based on the fourth embodiment (see FIG. 13), therefore, it is understood that sheet of paper 40 can be ejected without wrinkles and the like by using guide member 70.

### EXAMPLE 3

Referring again to FIG. 15, Example 3 will be described. In Example 3, sheet conveying device 20B based on the third embodiment (see FIGS. 11 and 12) and fixing device 50A based on the fourth embodiment (which includes fixing units 10 and 30 as fixing units) (see FIG. 13) were used.

Under these conditions, 250 sheets of paper 40 of A3 size were conveyed. As sheets of paper 40, OK Topcoat+ (Topcoat is a registered trademark) available from Oji Paper Co., Ltd. was used. As sheets of paper 40, sheets having a weight per unit area of 127.9 g/m² and sheets having a weight per unit area of 79.1 g/m² were used. A state of each sheet of paper 40 ejected from fixing unit 30 was confirmed.

As a result, as shown in FIG. 15, in Example 3, the frequency of occurrence of wrinkles in sheets of paper 40 having a weight per unit area of 127.9 g/m² was 0 sheet out of 250 sheets, and the frequency of occurrence of wrinkles in sheets of paper 40 having a weight per unit area of 79.1 g/m² was also 0 sheet out of 250 sheets.

According to sheet conveying device 20B based on the third embodiment (see FIGS. 11 and 12) and fixing device 50A based on the fourth embodiment (see FIG. 13), therefore, it is understood that sheet of paper 40 can reliably be ejected without wrinkles and the like by using guide member 70, controller 74 and the like.

In the embodiments described above, one liquid development device 44 is arranged around photoconductor drum 41 (see FIG. 1). A plurality of liquid development devices 44 may be prepared to form a color image. A method of color development and the presence or absence of intermediate transfer may be arbitrarily set. Depending on the method of color development and the presence or absence of intermediate transfer, photoconductor drum 41 and liquid development device 44 can be arbitrarily arranged.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A sheet conveying device configured to convey a sheet of paper from upstream to downstream of a conveying route, comprising
a plurality of wire ropes configured to support and convey the sheet of paper in the conveying route, wherein
said plurality of wire ropes are arranged apart from each other, and
at least two of said wire ropes are arranged so that a distance between them becomes larger as they come closer to downstream of the conveying route.

2. The sheet conveying device according to claim 1, wherein
the other ropes are arranged so that they are in parallel from upstream to downstream of the conveying route.

3. The sheet conveying device according to claim 1, wherein
the ropes in an inner side of the plurality of wire ropes in a width direction of the conveying route are arranged in parallel and the ropes in an outer side of the plurality of wire ropes are arranged so that a distance between any two of them becomes larger as they come closer to downstream of the conveying route.

4. The sheet conveying device according to claim 1, wherein
all the ropes are arranged so that a distance between any two of them becomes larger as they come closer to downstream of the conveying route.

5. The sheet conveying device according to claim 1, further comprising
a wind pressure generator configured to generate wind to press the sheet of paper being conveyed in the conveying route against the plurality of wire ropes.

6. The sheet conveying device according to claim 1, wherein
a distance between the ropes is determined so that the sheet of paper is conveyed diagonally in a direction toward the wire ropes in the outer side of the plurality of wire ropes, and
said sheet conveying device further comprises a guide member configured to regulate travel of the sheet of paper conveyed diagonally so that the sheet of paper will not travel in the direction beyond a predetermined distance.

7. The sheet conveying device according to claim 6, further comprising:
a wind pressure generator configured to generate wind to press the sheet of paper being conveyed in the conveying route against the plurality of wire ropes;
a detector configured to detect that the sheet of paper conveyed diagonally has reached a predetermined position; and
a controller configured to control a driving amount of the wind pressure generator in response to a result of the detection so that a travel distance of the sheet of paper in the diagonal direction does not exceed the predetermined distance.

8. A fixing device comprising:
a fixing unit configured to fix to a sheet of paper the toner image transferred thereon by an image transfer member; and
a sheet conveying device configured to convey the sheet of paper from upstream to downstream of a conveying route, said sheet conveying device including a plurality of wire ropes configured to support and convey the sheet of paper in the conveying route, said plurality of wire ropes being arranged apart from each other, and at least two ropes being arranged so that a distance between them becomes larger as they come closer to downstream of the conveying route.

9. The fixing device according to claim 8, wherein
the other ropes of the sheet conveying device are arranged so that they are in parallel from upstream to downstream of the conveying route.

10. The fixing device according to claim 8, wherein
the sheet conveying device includes the ropes in an inner side of the plurality of wire ropes in a width direction of the conveying route that are arranged in parallel and the ropes in an outer side of the plurality of wire ropes that are arranged so that a distance between any two of them becomes larger as they come closer to downstream of the conveying route.

11. The fixing device according to claim 8, wherein
a distance between the ropes of the sheet conveying device is determined so that the sheet of paper is conveyed diagonally in a direction toward the wire ropes in the outer side of the plurality of wire ropes, and
said sheet conveying device further includes a guide member configured to regulate travel of the sheet of paper conveyed diagonally so that the sheet of paper will not travel in the direction beyond the predetermined distance.

12. The fixing device according to claim 8, wherein the sheet conveying device further includes
a wind pressure generator configured to press the sheet of paper being conveyed in the conveying route against the plurality of wire ropes,
a detector configured to detect that the sheet of paper conveyed diagonally has reached a predetermined position, and
a controller configured to control a driving amount of the wind pressure generator in response to a result of the detection so that a travel distance of the sheet of paper in the diagonal direction does not exceed the predetermined amount.

13. A wet-type image forming apparatus comprising;
an image carrying member configured to carry thereon an electrostatic latent image;
a development device configured to develop with a liquid developer the electrostatic latent image on the image carrying member into a toner image, said liquid developer including carrier liquid and toner dispersed therein;
an image transfer member configured to transfer the toner image developed by the development device onto a sheet of paper;
a fixing device configured to fix to the sheet of paper the toner image transferred thereon by the image transfer member; and
a sheet conveying device configured to convey the sheet of paper from upstream to downstream of a conveying route, said sheet conveying device including a plurality of wire ropes configured to support and convey the sheet of paper in the conveying route, said plurality of wire ropes being arranged apart from each other, and at least two ropes being arranged so that a distance between them becomes larger as they come closer to downstream of the conveying route.

14. The wet-type image forming apparatus according to claim 13, wherein
the other ropes of the sheet conveying device are arranged so that they are in parallel from upstream to downstream of the conveying route.

15. The wet-type image forming apparatus according to claim 13, wherein
the sheet conveying device includes the ropes in an inner side of the plurality of wire ropes in a width direction of the conveying route that are arranged in parallel and the ropes in an outer side of the plurality of wire ropes that are arranged so that a distance between any two of them becomes larger as they come closer to downstream of the conveying route.

16. The wet-type image forming apparatus according to claim 13, wherein
all the ropes of the sheet conveying device are arranged so that a distance between any two of them becomes larger as they come closer to downstream of the conveying route.

17. The wet-type image forming apparatus according to claim 13, wherein
the sheet conveying device further includes a wind pressure generator configured to generate wind to press the sheet of paper being conveyed in the conveying route against the plurality of wire ropes.

18. The wet-type image forming apparatus according to claim 13, wherein
a distance between the ropes of the sheet conveying device is determined so that the sheet of paper is conveyed diagonally in a direction toward the wire ropes in the outer side of the plurality of wire ropes, and
said sheet conveying device further includes a guide member configured to regulate travel of the sheet of paper conveyed diagonally so that the sheet of paper will not travel in the direction beyond the predetermined distance.

19. The wet-type image forming apparatus according to claim 13, wherein the sheet conveying device further includes
a wind pressure generator configured to press the sheet of paper being conveyed in the conveying route against the plurality of wire ropes,
a detector configured to detect that the sheet of paper conveyed diagonally has reached a predetermined position, and
a controller configured to control a driving amount of the wind pressure generator in response to a result of the detection so that a travel distance of the sheet of paper in the diagonal direction does not exceed the predetermined amount.

20. The wet-type image forming apparatus according to claim 13, wherein
the sheet conveying device carries and conveys the sheet of paper after the transferred toner image has been fixed thereon by the fixing device.
